(19) United States
(12) Patent Application Publication
(10) Pub. No.: US 2013/0000367 A1
(43) Pub. Date: Jan. 3, 2013

(54) Disk Tumbler Lock and an Improved Key and Restrictive Keyway

(76) Inventor: Norman Binz DeWalch, Houston, TX (US)

(21) Appl. No.: 13/175,818

(22) Filed: Jul. 1, 2011

Related U.S. Application Data
(63) Continuation-in-part of application No. 13/174,776, filed on Sep. 15, 2011, now abandoned.
Application No. 13/174,776 is a continuation-in-part of application No. 13/174,778, filed on Jul. 1, 2011, now abandoned.

(51) Int. Cl. E05B 35/00

(52) U.S. Cl. 70/356

(57) ABSTRACT

A disc tumbler lock having a code range angle, the disc tumbler lock including at least: at least one tumbler and a guard tumbler, the at least one tumbler and the guard tumbler defining a keyway aperture there through; wherein the at least one tumbler includes at least: a key engaging surface defining a key engaging zone, the key engaging zone having a first radius defining the major extent of the key engaging zone, and the key engaging zone having a second radius defining the minor extent of the key engaging zone; wherein the guard tumbler defines: a restrictive aperture comprising a restrictive width having a minimum dimension less than or equal to the sum of the first radius defining the major extent of the key engaging zone and the second radius of the minor extent defining the key engaging zone multiplied by the sine of one half of the following: the code range angle of the lock, minus the angular measure between a last code angle for the lock and a second to last code angle for the lock, minus the angular span of the key engaging surface.

### CROSS-REFERENCE TO RELATED APPLICATIONS

This application is a continuation-in-part of application Ser. No. 13/174,776 (entitled “Disk Lock”), filed Jul. 1, 2011 and this application is also a continuation-in-part of application Ser. No. 13/174,778 (entitled “Disc Tumbler Lock and an Improved Key and Keyway”), filed Jul. 1, 2011.

All written material, figures, content and other disclosure in each of the above-referenced applications is hereby incorporated by reference.

### BACKGROUND OF THE INVENTION

The present invention relates generally to a locking apparatus as well as a locking system and methodology, and more specifically, it relates to a locking apparatus such as a disc tumbler lock and an improved key and keyway for the same adapted for securing at least one structure or a plurality of structures and which may be used in many various locking applications such as, but not limited to those described herein such as utility revenue protection, securing trucking, shipping, airline or other transportation or cargo containers or with door locking hardware, in a padlock or other locking hardware. In one example use, the locking apparatus may be used to secure a utility service enclosure, or for example, a watthour meter socket box to prevent unauthorized access as noted in more detail below.

As noted above, one common use relates to revenue protection in the utility industry. For example, in the electric utility industry, electrical service providers generally deliver electricity to their customers via power lines buried underground or distributed along poles or towers overhead. The provider's power lines are usually distributed from a power generation station to numerous sets of customer lines, so that customers can then use the power to satisfy their various electrical needs. To measure delivered power so that customers can be billed in proportion to their usage, service providers typically terminate their power lines at a customer's home or business facility through a metered socket box, various designs for which are well known.

A meter box is generally used by electric utility companies, however the invention herein may be used with other utility service enclosures in the gas, water, cable, TV utility industries, or in shipping or other industries as well.

An example of one previously known meter box consists of two sets of electrical posts, with a provider's transmission lines being connected to one set of posts, and the customer's service lines to the other set. In order to measure the amount of electricity a customer uses, the meter box is configured to accept a watt-hour meter or another electricity usage measurement device, which, when plugged into the socket box, permits transmission of electricity from the provider to the customer and allows the amount of transmitted electricity to be accurately measured, so that the provider can charge the customer for power usage at an appropriate rate.

Various designs and uses for watthour meters are also well known, and all such designs and uses are incorporated by reference into the teachings of the present invention. The present invention is also applicable in situations where the customer's service lines are routed from the meter box to a breaker box so that electricity can be distributed to multiple service locations using additional sets of electrical lines or wires. Presently, there are various types of meter socket boxes, each distinguished by the manner in which the meter is secured in place once it has been plugged into an electrical socket disposed in the meter box. For example, a ringed-type meter box fitted with a flanged front cover is known, within which a watthour meter is disposed so that a head portion of the meter passes out through a flanged opening in the front cover. In this configuration, the meter is generally held in place using an annular, lockable sealing ring.

Also known is a ringless type meter box, in which the box cover secures the meter in place. For example, a ringless type meter box may include a box cover and a box base. A ringless type meter box includes an installed meter and a box cover. Formed around an opening in a central portion of meter box cover is a flange; a complementary flange is disposed on meter such that, when meter box cover is installed over and around the head of meter, for example, then the meter complementary flange is encased by meter box cover flange, and complementary flange sections and join together, so that the meter cannot be easily removed from the electrical socket unless the cover is first removed from the meter box or meter box base.

The meter box cover is typically secured in place by means of a small latch assembly, which functions in structural cooperation with a complementary latch-receiving member disposed on the meter box or base. The meter box cover is used to secure the meter to the electrical socket (not shown), so that completion of an electrical circuit is ensured, and the meter is reliably prevented from falling out of the meter box socket.

The meter box cover also prevents unauthorized persons from tampering with the meter. For example, some customers have attempted to bypass the meter, so that unmeasured electricity could be used free of charge. Also, service providers are sometimes forced to disconnect service to customers, for example, due to non-payment of monthly bills. In this event, a locked meter box cover helps prevent a customer from entering the meter box and reconnecting electrical service. However, in instances where the small latch assembly on the meter box fails to provide sufficient security for preventing unauthorized access to the meter and meter box socket, a sturdier, more tamper resistant solution is required.

One of the problems presented by typical locking devices is that the keyway of the locking device can be readily accessed and sometimes a simple key blank can be used defeat these locking devices. Key control is an important aspect of lock security and control of the blanks used to make a key for a lock is important to help control security of the overall system.

There remains a need for a locking apparatus which provides a keyway and key for a disc tumbler locking system that prevents a user from using a simple blank to fabricate an un-authorized key. There is also a need to provide a restricted key aperture to prevent the insertion of pick tools, drills or other implements that may compromise the lock. There also remains a need, for example, for a locking apparatus and locking method adapted for restricting access to a keyway through the key aperture in order to prevent insertion of a key wide enough to create the appropriate cuts to open the lock.

Those of skill in the art will appreciate the example embodiments of the present invention which addresses the above needs and other significant needs the solution to which are discussed hereinafter.

### SUMMARY OF THE INVENTION

One example embodiment of the present invention provides a keyway and key for a disc tumbler locking system that prevents a user from using a simple blank to fabricate an un-authorized key.

Another example embodiment of the present invention provides a restricted key aperture to prevent the insertion of pick tools, drills or other implements that may compromise the lock.

In an example embodiment, a locking apparatus is provided including at least a disc tumbler locking system adapted to secure a watthour meter box sealing ring to a watthour meter box.

In another example embodiment of the present invention, which will be described subsequently herein, a locking apparatus is used to secure at least one structure or a plurality of structures, to lock a utility service enclosure, such as for example, a meter box locking ring having flanged ends.

In this respect, before explaining the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The content and disclosure of each of the following applications/publications, as well as their related parent or child continuation, continuation-in-part or divisional applications, as permitted are specifically hereby incorporated by reference: U.S. Pat. Nos. 4,742,703, 6,386,006, 7,213,424, 7,176,376; and U.S. patent application Ser. Nos. 12/380,938, 12/378,879, 12/317,086, 12/082,122, 13/174,776, 13/174,778, 61/316,851, 61/293,724; and U.S. Provisional Application No. 61/360,375, and U.S. Patent Application Nos. based on Attorney Docket Nos. PAT-017 DIVA and PAT-067 PPA.

Additionally, all written material, figures, content and other disclosure in each of the above-referenced applications, as well as their related parent or child continuation, continuation-in-part or divisional applications, is hereby incorporated by reference. In addition, the instant application claims priority as noted above.

There has thus been outlined, rather broadly, the more important features of the invention in order that the detailed description thereof may be better understood, and in order that the present contribution to the art may be better appreciated. There are additional features of the invention that will be described hereinafter.

These and other aspects, aspects, features, and advantages of example embodiments of the present invention will become apparent from the drawings, the descriptions given herein, and the appended claims. Further aspects, features, and aspects are also indicated herein in various example embodiments of the invention. However, it will be understood that objectives and/or advantages herein of example embodiments are intended only as an aid in quickly understanding aspects of the example embodiments, are not intended to limit the embodiments of the invention in any way, and therefore do not form a comprehensive or restrictive list of objectives, and/or features, and/or advantages.

To the accomplishment of the above and related aspects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other aspects, features and attendant advantages of the embodiments of the invention will become fully appreciated as the same becomes better understood when considered in conjunction with the accompanying drawings, and wherein:

FIG. 1 shows an isometric view of a barrel lock with a key inserted comprising an embodiment of the present invention.

FIG. 2 shows an isometric view of the locking mechanism of a barrel lock with a key inserted comprising an embodiment of the present invention wherein the tumblers are all in the locked position.

FIG. 3 shows an isometric view of the locking mechanism of a barrel lock with a key inserted comprising an embodiment of the present invention wherein the tumblers are all in an unlocked position.

FIG. 4 shows an exploded view of a barrel lock and key comprising an embodiment of the present invention.

FIG. 5 shows a cross-sectional view of a barrel lock with a key inserted comprising an embodiment of the present invention; the lock is in the locked position and the key is shown as it is inserted into the keyway.

FIG. 6 shows a cross-sectional view of a barrel lock with a key inserted comprising an embodiment of the present invention; the lock is in the locked position and the key has been turned partially in the clockwise direction as occurs when the lock is being opened.

FIG. 7 shows a cross-sectional view of a barrel lock with a key inserted comprising an embodiment of the present invention; the lock and key are in the un-locked position.

FIG. 8 shows a top view of a guard tumbler with the key inserted in the keyway; the key is shown in cross-section.

FIG. 9 shows an isometric view of a guard tumbler.

FIG. 10 shows a side view of an embodiment of a key of the present invention.

FIG. 11 shows an end view of an embodiment of a key of the present invention.

FIG. 12 shows an isometric view of an embodiment of a key of the present invention.

FIG. 13 shows an end view of an embodiment of a key of the present invention; the dashed lines representing various cuts for various codes in accordance with the present invention.

FIG. 14 shows an end view of an embodiment of a key of the present invention; the dashed lines representing various cuts for various codes in accordance with the present invention. A simple rectangular blank is superimposed on the view.

FIG. 15 shows a top view of a code tumbler embodiment in accordance with the present invention.

FIG. 16 shows an isometric view of a code tumbler embodiment in accordance with the present invention.

FIG. 17 shows an isometric view of a code tumbler embodiment in accordance with the present invention with dashed lines indicating all of the code notch positions for the embodiment shown.

FIG. 18 shows a view of a code tumbler embodiment in accordance with the present invention with a key inserted into the keyway. The dashed lines on the key indicate all of the code cut positions for the key embodiment shown.

FIG. 18A shows a view of a code tumbler embodiment in accordance with the present invention with construction lines indicating the relationship between key cut angles and the keyway geometry.

FIGS. 19-35 include various views of embodiments including certain members, components, structures, and configurations in accord with possible embodiments of the invention.

While various example embodiments of the invention will be described herein, it will be understood that it is not intended to limit the invention to those embodiments. On the contrary, it is intended to cover all alternatives, modifications, and equivalents included within the spirit of the invention.

### DETAILED DESCRIPTION OF THE INVENTION

Turning now descriptively to the drawings, in which similar reference characters may denote similar elements throughout the several views, the various figures attached illustrate a locking apparatus comprising a disc tumbler lock and key. In one example embodiment, the locking apparatus may be used for various locking applications such as, for example, securing a plurality of structures or a portion of a utility service enclosure as will explained further herein. Disc tumbler locks are well known for their excellent resistance to corrosion and reliable, long term operation. The geometry needed to make a key for a disc tumbler lock requires that there be sufficient material on the key, in the region that interacts with the tumbler, to allow cuts to be made of the appropriate depth to rotate the locking tumblers into position to allow the lock to be opened. This being the case, locks built previously have had keyways that have not restricted the keyways sufficiently to prevent simpler key blanks from being used. One example embodiment of the present invention is to provide geometry for the keyway in the code tumblers and the guard tumbler to prevent simpler key blanks from being used to fabricate a key for a lock in accordance with the present invention.

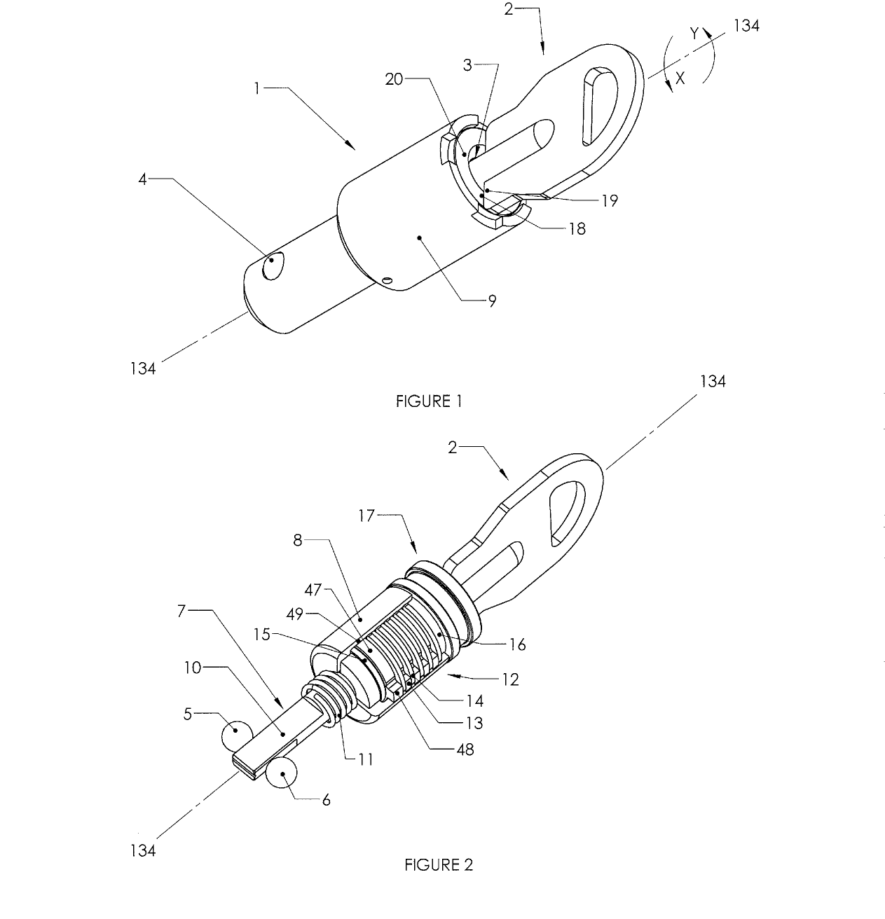

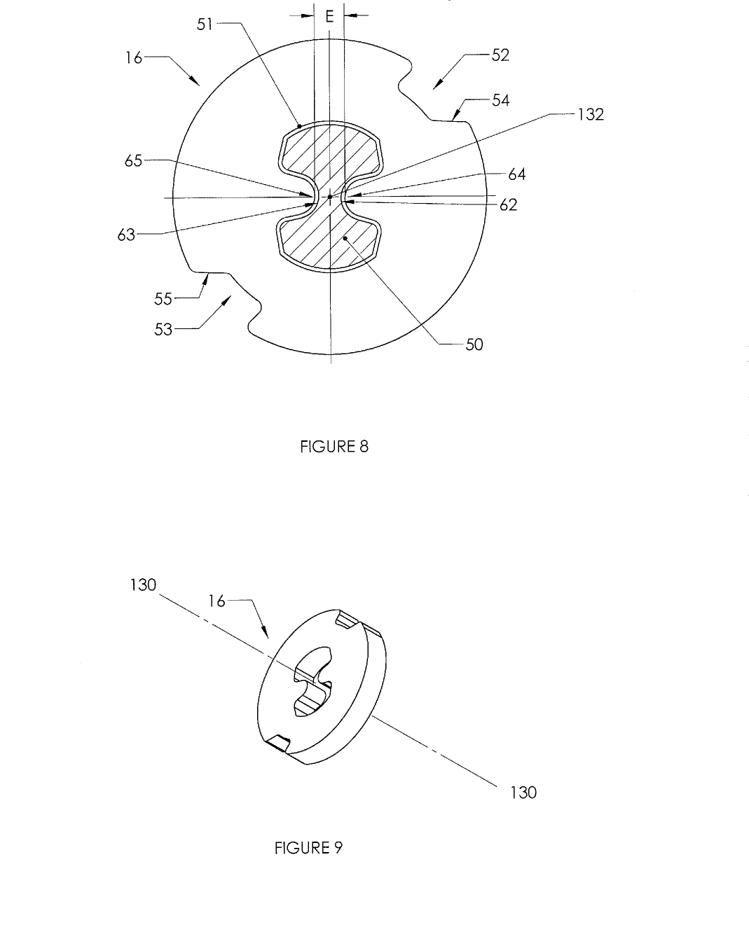

Referring to FIG. 1, a barrel lock 1 comprises a lock 1 and key 2 constructed in accordance with one example embodiment of the present invention. The key is inserted into the keyway 3 of the lock and the lock is in the locked configuration. As is well understood by those skilled in the art, the balls 4 which serve as retaining members are in the extended or “locked” position. However, in other embodiments, other types of retaining members (e.g., pegs, or for example, other protuberances) which would be suitable may also be used. FIG. 2 shows an exemplary embodiment of the present invention with the case 9 of the barrel lock removed. The locking members 5 and 6 interact with the rotor stem 7 which is coupled to the rotor 8. When the lock is in the locked configuration, the rotor 8 cannot rotate relative to the case 9 of the lock and cannot rotate the rotor stem 7 so that the flats 10 allow the balls 5 and 6 (locking members) to retract. The spring 11 maintains a compressive force on the stack of tumblers 12 to hold the tumblers in position until moved by the key 2. The spring does this by increasing the friction between the tumblers such as 13 and the spacers such as 14. The purpose of the spacers is to isolate the tumblers from one another so that the motion of one tumbler is not transferred to an adjacent tumbler. At the base of the tumbler stack 12 is an anti drill member 15, in this case a disc, its purpose is to prevent attack by drilling. If a drill contacts the disk it will spin and prevent penetration of the drill. At the key entry end of the tumbler stack 12 is placed a guard tumbler. A guard tumbler 16 in accordance with the present invention is also shown in FIG. 8 and FIG. 9. Adjacent to the guard tumbler shown in FIG. 2 is an end cap 17. In the present embodiment the key makes contact with the external face of the endcap at 18 as shown in FIG. 1. In this embodiment the contact between the shoulder 19 on the key and the face 20 of the endcap establishes the alignment of the cuts on the key and the appropriate tumbler.

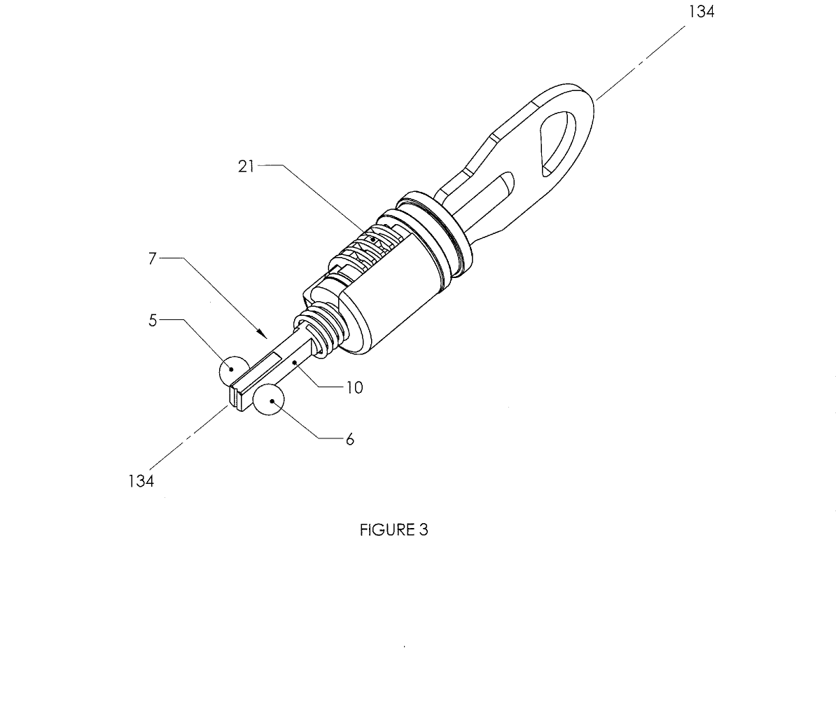

FIG. 3 shows internal components of a lock in accordance with the present invention in the unlocked configuration with the rotor stem 7 rotated to the unlocked position and the retaining members 5 and 6 retracted against the flats 10 on the rotor stem. The tumblers such as 21 have been rotated to their un-locked positions.

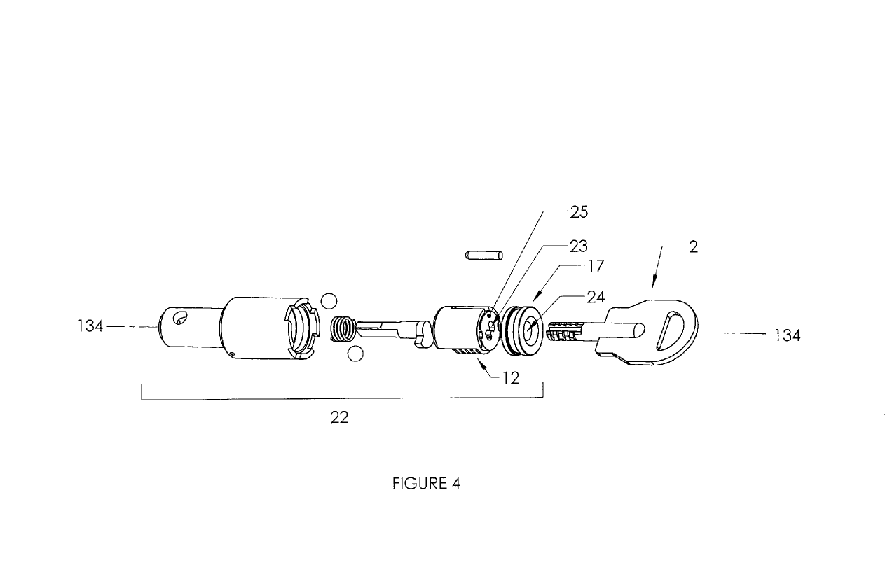

FIG. 4 shows an exploded view of the lock 22 and the key in alignment with the key way 23. The keyway in the present embodiment is formed by the key hole 24 in the endcap 17 and the apertures of each of the tumblers in the tumbler stack 12. The guard tumbler can be seen at 25. The guard tumbler in the present embodiment has a key aperture shape that is complimentary to the cross-sectional shape of the key. The shape of the aperture in the guard tumbler is restrictive and is configured so as to prevent simpler key shapes from being used to open the lock. This shape will be discussed further below.

FIGS. 5 through 7 illustrate a typical operating cycle of a single tumbler and its corresponding key portion in an exemplary embodiment lock and key. FIG. 5 shows the tumbler 26 and key 27 in the locked configuration. In the locked configuration the tumbler is rotated so that the fence receiving notch 28 is not aligned with the fence slot 29 in the rotor 30 and the fence 31 projects beyond the outer diameter of the rotor 32 into a longitudinal slot 33 in the case, preventing the rotor from rotating relative to the case 34. The rotation limiting tab 35 on the tumbler is contacting the rotor at 36. This contact allows the tumblers to return to an aligned position when the key is rotated counter clockwise just prior to removal of the key.

In some example embodiments, it should be noted that anti-rotation features are used such that user does not have to grasp the lock body to prevent it from rotating. For example, in one embodiment as shown in FIG. 1 notches are disposed intermittently around the end of the case 9 proximate the end cap 18 and are adapted to be intercooperatively engaged by protuberances of a key. One example embodiment of an operable anti-rotation key is shown in FIG. 20.

In another example embodiment, a flat or other suitable structure can be formed on the lock shank and adapted for use with a cooperative rotation restricting surface on lock receiving hardware so as to prevent rotation of the lock case while the key is being used to lock and unlock the lock, without having to grasp the key. For example, the configuration provided in U.S. Pat. No. 7213424 or U.S. application Ser. No. 11/800,862, incorporated by reference herein, could be used.

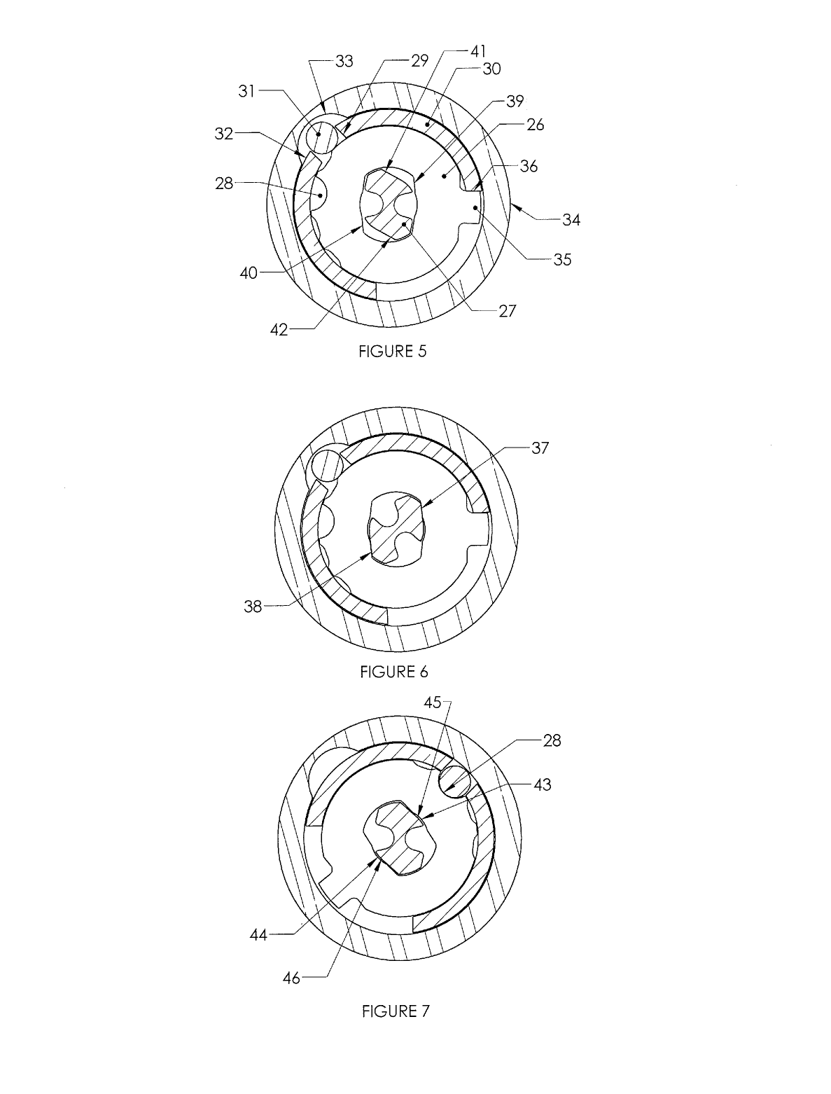

Referring now to FIG. 6, the key is shown at a position during the un-locking cycle where the key has just contacted the tumbler at 37 and 38. Referring again to FIG. 5, prior to rotating to the position shown in FIG. 6, the key makes no contact with the key engaging surfaces 39 and 40 and the tumbler therefore stays in position. When the tumbler engaging surfaces 41 and 42 on the key contacts the tumbler as shown in FIGS. 6 at 37 and 38 the tumbler is then engaged by the key and rotates with the key until the key reaches its stop position. Relief is provided at 43 and 44 to provide clearance for the shaft of the key at 45 and 46 while the key is being rotated. This relief also minimizes the key engaging surface accessible to an un-authorized key blank. The relief in the present embodiment is generally an arc that is centered generally at the center of rotation of the key. However, in other embodiments the relief may not be arched or curved and may be squared-off, linearly, or configured differently as suitable.

In the present embodiment the bottom tumbler 47 as shown in FIG. 2 is designed so that the fence receiving notch is aligned with the fence slot in the rotor after the tumbler has been rotated a full 90 degrees in the clockwise direction. The tab 48 on this tumbler contacts the tumbler rotation limiting surface on the rotor 49 and prevents the tumbler from being rotated further. The key is designed to couple with this tumbler so that there is minimal relative rotation of the key relative to the tumbler. This interaction between the key and the bottom tumbler restricts the keys rotation to a range that corresponds to the various positions for the code tumblers in the lock.

FIG. 7 shows the key, code tumbler and rotor rotated to the unlocked position. The code tumbler has been rotated by the key so that the fence receiving notch 28 has been aligned with the fence slot in the rotor and the fence has been cammed into the notch allowing the rotor to rotate.

FIG. 8 shows a top view of a guard tumbler 16 in accordance with the present invention. A key 50 is inserted in the keyway 51 and is shown in cross-section. The key shown in FIG. 8 has no code cuts made in its periphery. The guard tumbler shown in the present embodiment does not have a rotation limiting tab and therefore is free to spin in the rotor. This provides additional resistance to drilling. Also, the guard tumbler has two notches 52 and 53 to allow engagement of the key in either of the two insertion orientations. When the tumbler is rotated counter clockwise to re-lock the lock, the camming surface 54 and 55 in each of the notches cam the fence outward back into the slot in the case. FIG. 9 shows an isometric view of an example embodiment guard tumbler 16.

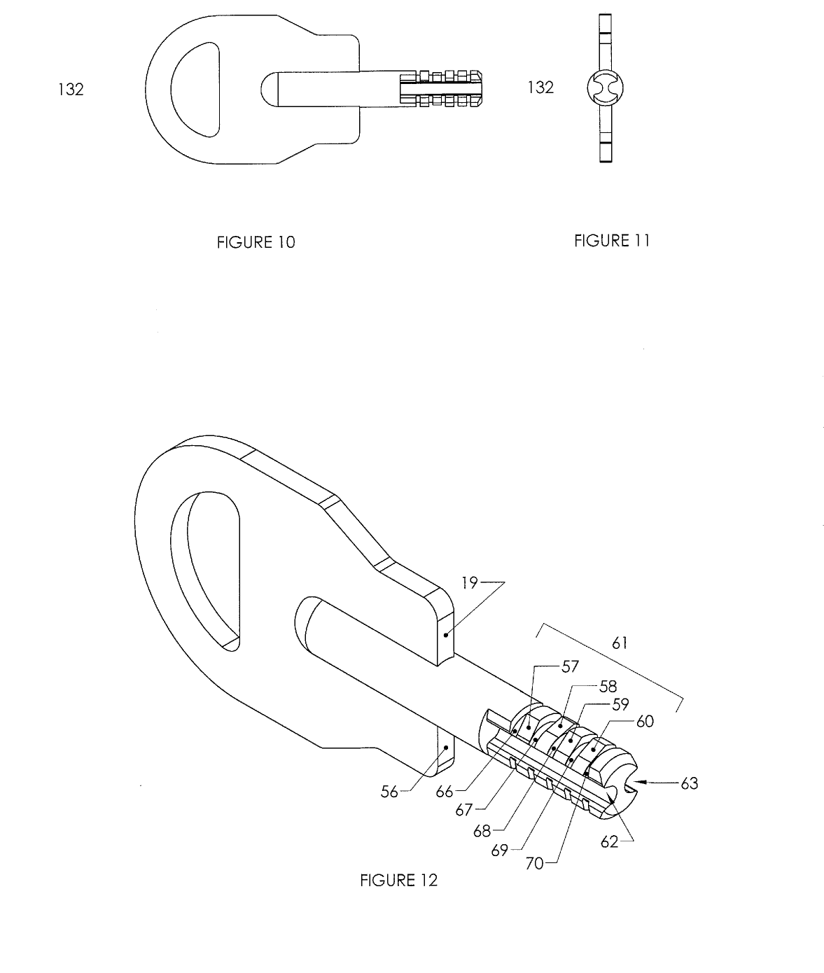

FIGS. 10, 11 and 12 show an example embodiment of a key in accordance with the present invention. The key has shoulders 19 and 56 which interact with the endcap to establish alignment of the key code cuts 57 through 60 and their corresponding code tumblers. The code cuts 57 through 60 are made in the code portion 61 of the key. Slots 62 and 63 provide clearance for the key to be inserted into the keyway formed by the tumbler stack and the guard tumbler as shown in FIG. 4. The restricting surfaces 64 and 65 as shown in FIG. 8 on the guard tumbler 16 form a restricting region. Dimension E in FIG. 8 illustrates the minimum dimension of the restricting region in the present embodiment. The restricting region prevents keys of simpler design from entering the keyway. The slots 62 and 63 on the key allow it to be inserted without interfering with the restricting surfaces 64 and 65 on the guard tumbler. Referring again to FIG. 12, circumferential grooves 67 through 70 are cut between each code position on the key to prevent interference with adjacent tumblers and to lower tolerance requirements to ease manufacturing.

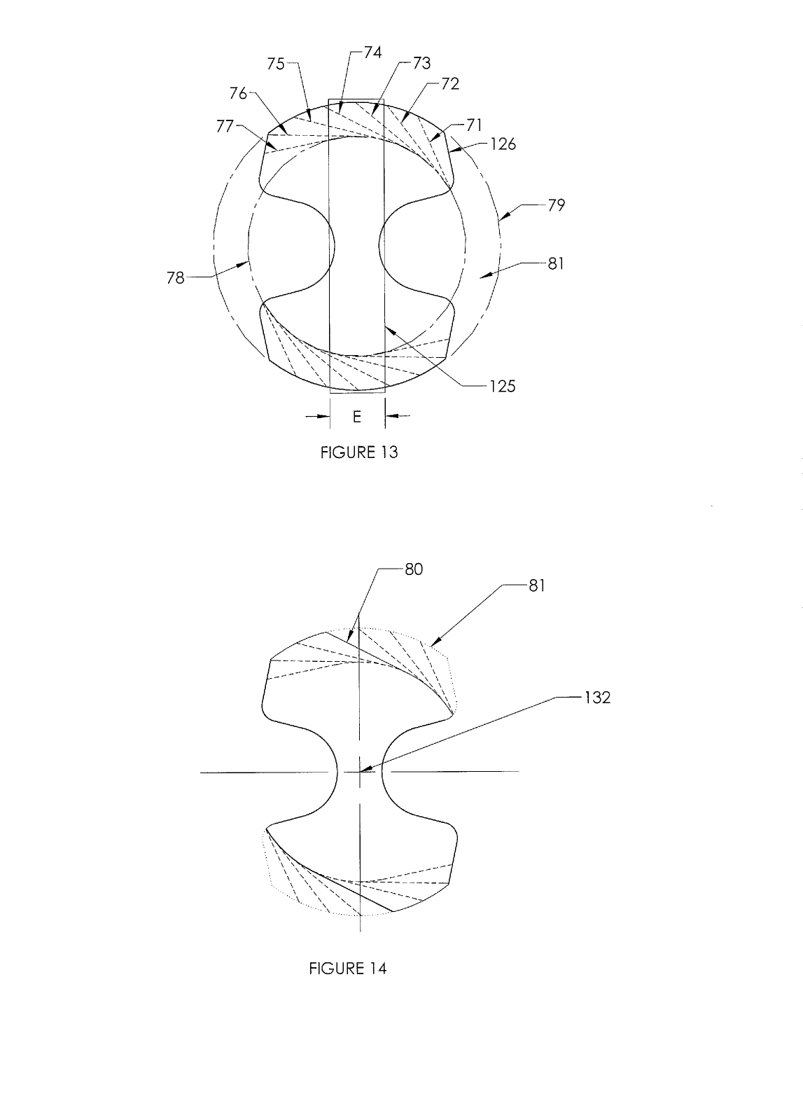

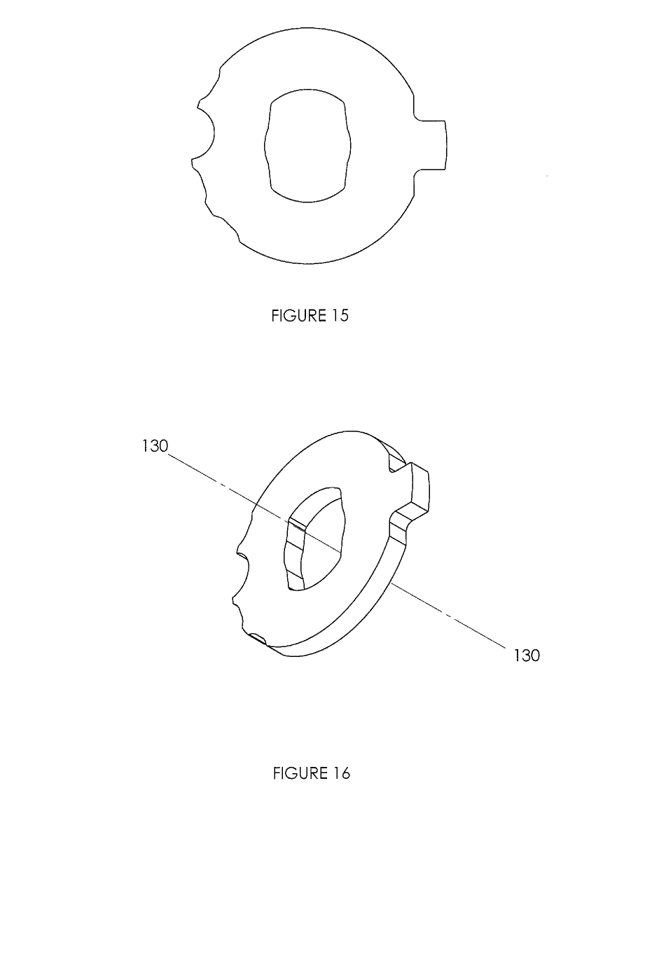

FIG. 13 shows an end view of the code portion 61 as shown in FIG. 12. The dashed lines 71 through 77 indicate code positions for cuts in the key. Arc 78 shows the minor extent of the tumbler engaging region and arc 79 illustrates the major extent of the tumbler engaging region. The arcs for each of the aforementioned regions are located generally at the center of rotation of the key.

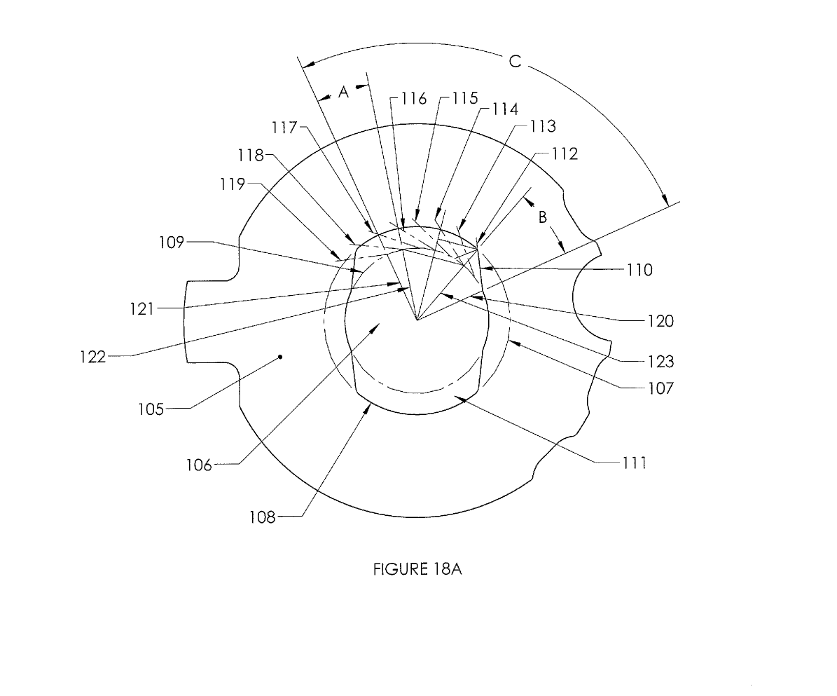

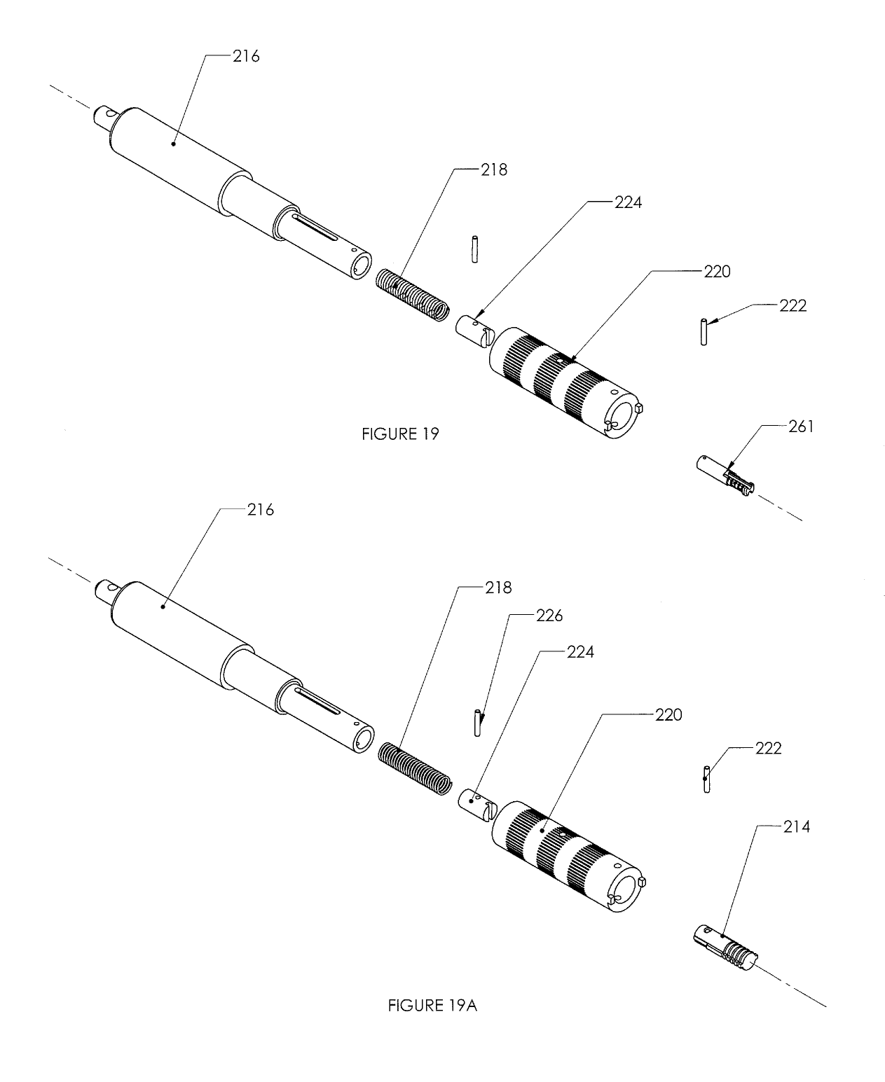

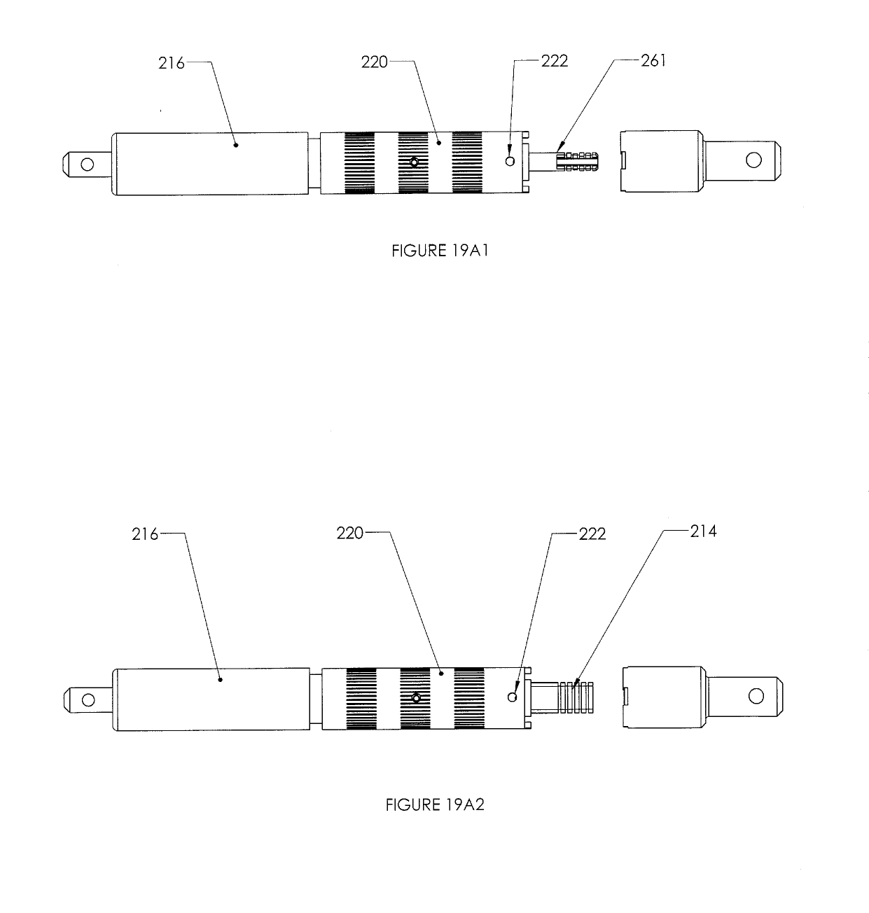

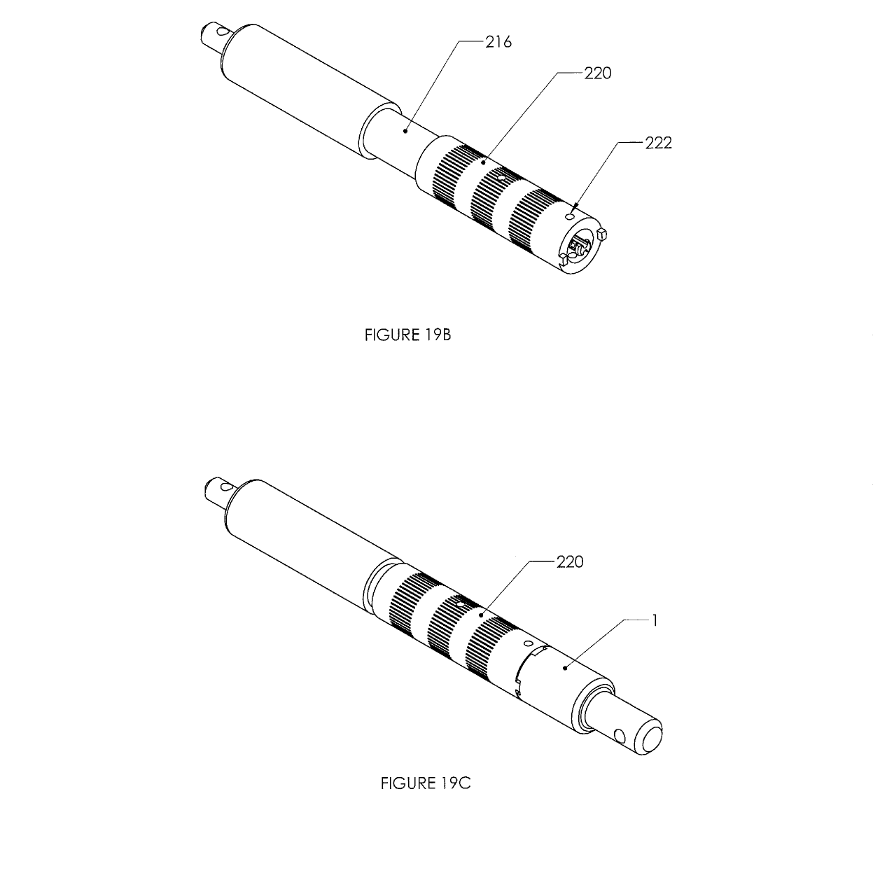

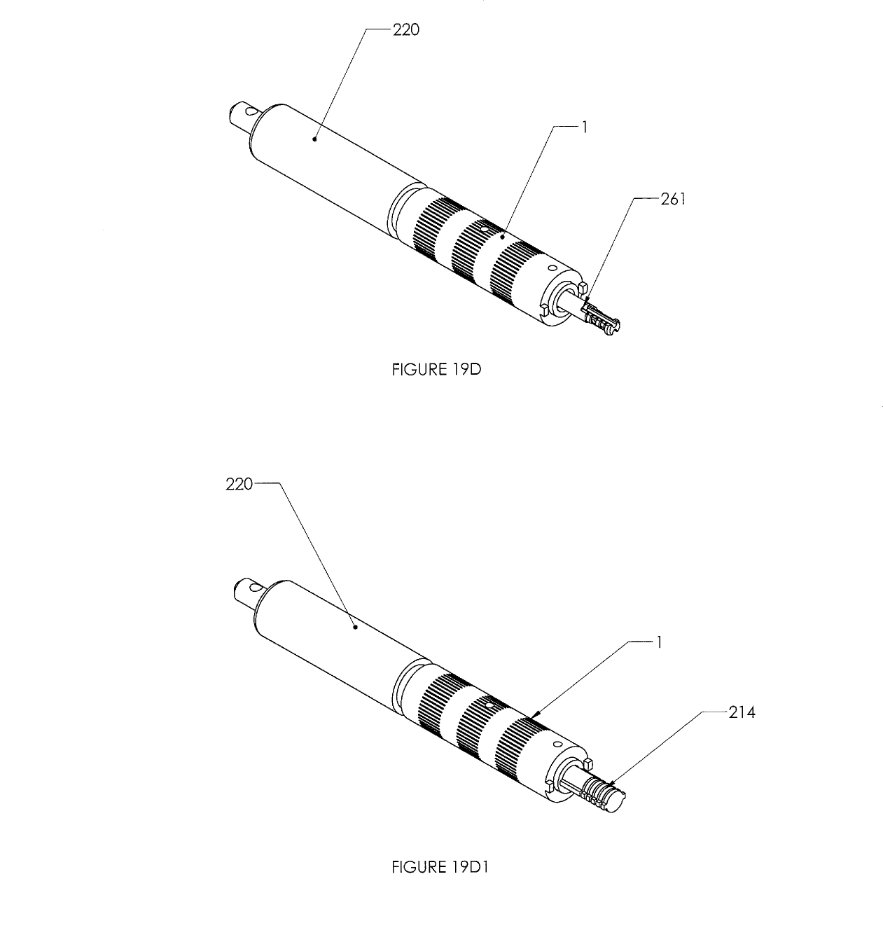

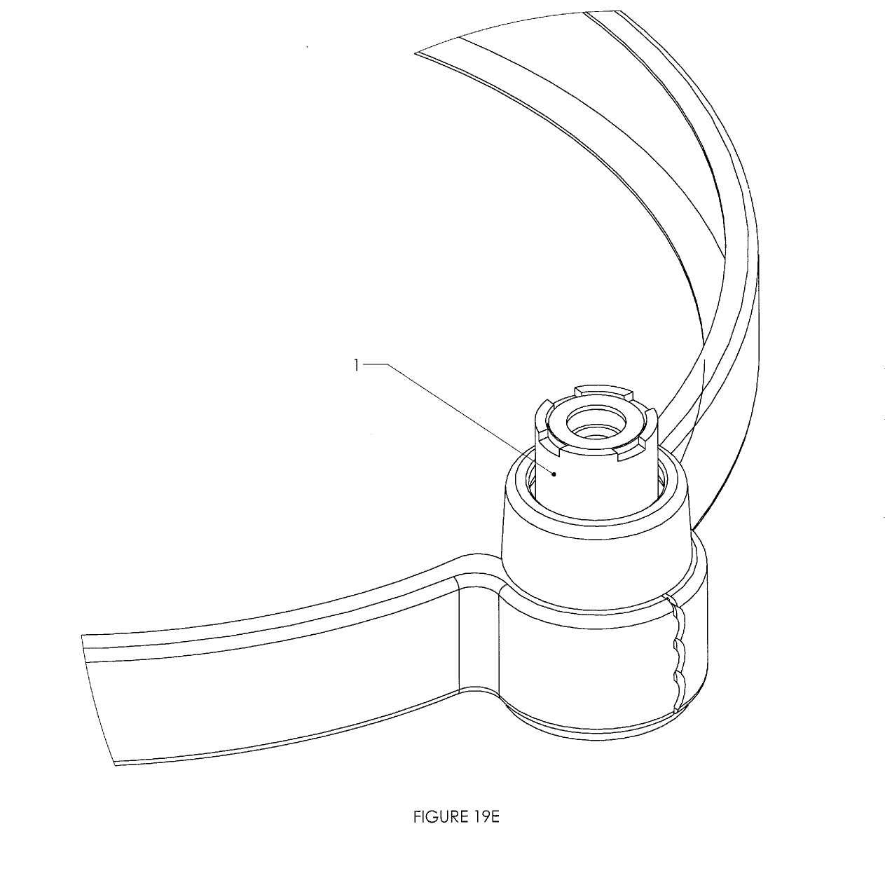

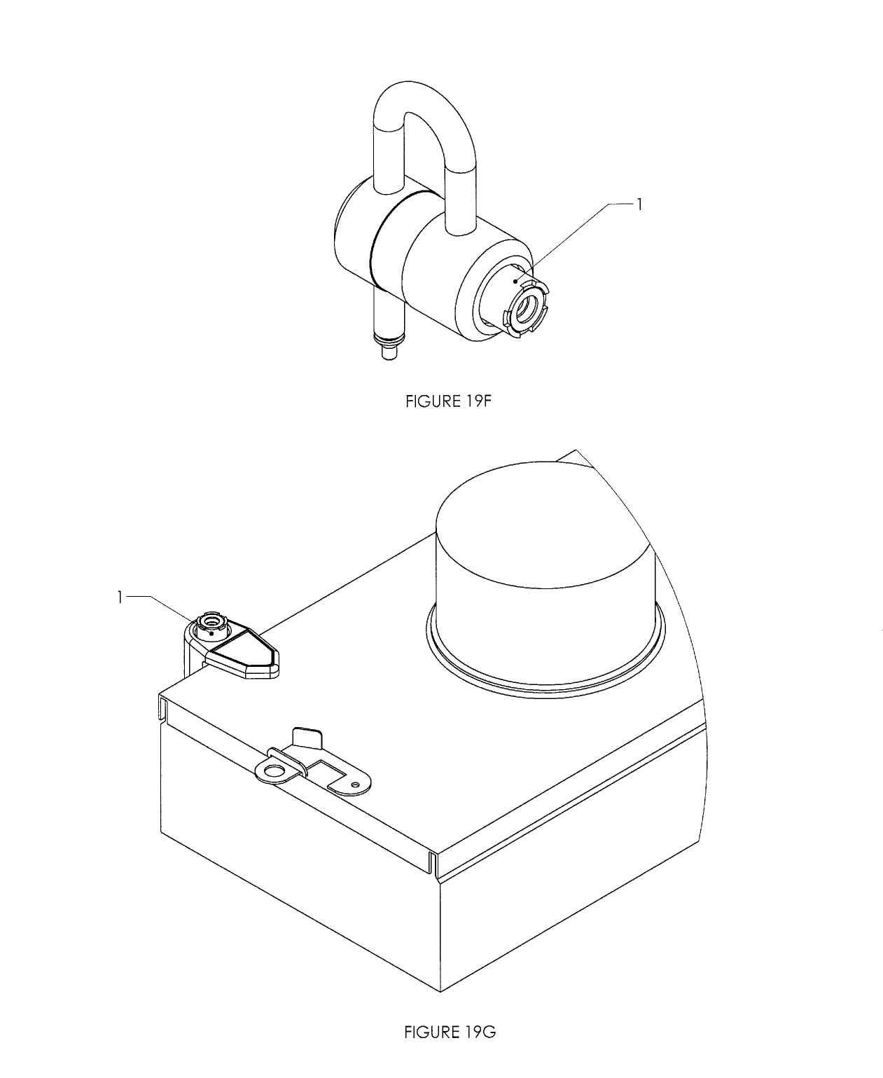

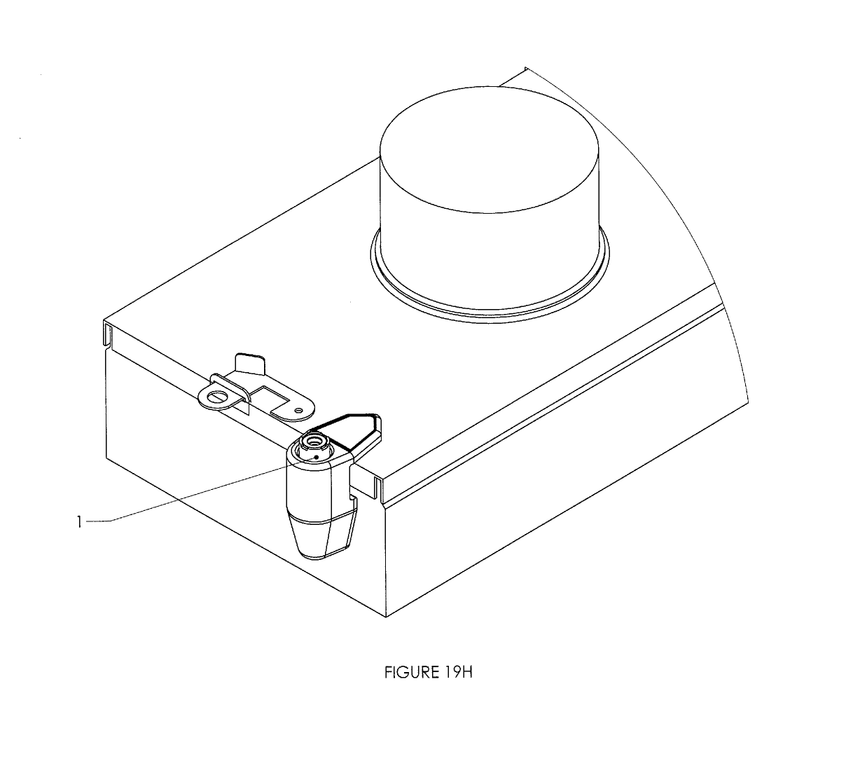

FIG. 14 shows a key that has been cut to the code position 74 as shown in FIG. 13. The dashed line 81 represents the material that was removed from the key blank. Each of the code cuts are designed to allow the key to rotate a set amount before picking up a code tumbler. The cuts are made in the tumbler engaging zone 81 of the key shaft. The tumbler engaging zone is the portion of the material that is capable of contacting a tumbler when the key is rotated. The tumbler engaging zone on the key is bounded by the minor extent of the tumbler engaging region 78 and the major extent of the tumbler engaging region 79 as shown in FIG. 13. FIG. 18 illustrates an un-cut key 82 and its interaction with a code tumbler 83. Dashed lines such as 84 indicate the locations of key cuts on the key for each of the 8 codes for the embodiment illustrated. Other embodiments could have more or less codes as well. The angular division of each of the codes could also be varied. In the current example embodiment all of the code angles are spaced equally in their angular measures. In other embodiments, as noted herein, they may be spaced unequally. The key 82 makes contact with the tumbler 83 at tumbler engaging surfaces 85 and 86 on the key and key engaging surfaces on the tumbler at the same location.

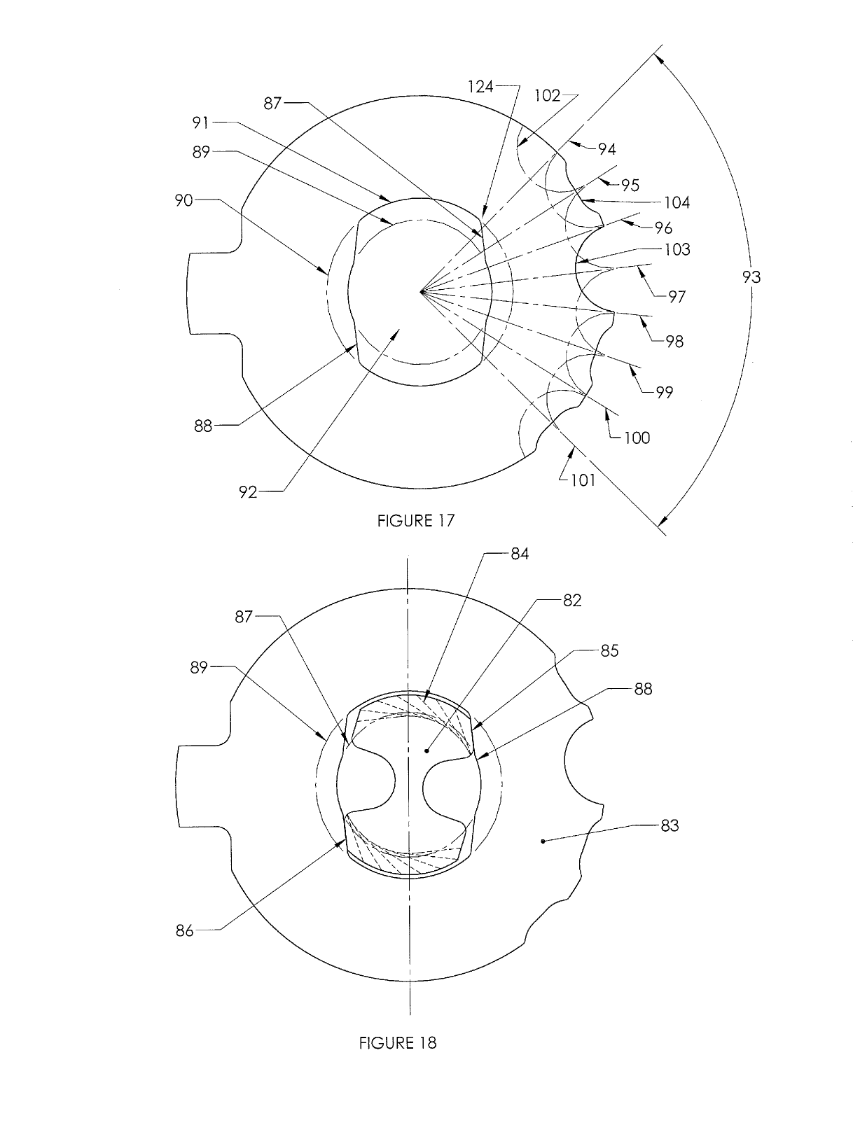

FIG. 17 shows an example code tumbler with keyway 92. The keyway is the aperture through which the key passes when inserted into the lock. FIG. 17 and illustrates key engaging surfaces 87 and 88 on the tumbler. The key engaging surfaces in the example embodiment shown in FIGS. 17 and 18 are generally straight surfaces. Other embodiments could have any variety of straight or curved surfaces to interact with a key designed in accordance with the current invention. The key engaging surfaces are the surfaces that a key will come in contact with when the key is rotated about its center of rotation or axis of rotation 132 in the lock in the un-locking direction. The locking direction is the opposite rotational direction from the un-locking direction. In the present embodiment as shown in FIG. 17 the un-locking direction is clockwise and the locking direction is counter clockwise. The key engaging surfaces exist in the key engaging zone which is bounded by the major extent 90 of the key aperture and the minor extent 89 of the key aperture. The major extent of the key aperture is generally an arc centered at the center of rotation of the key in the aperture with a radius determined by the portion of the key engaging surface that extends the furthest in the locking direction of the lock. In the present invention this point is generally at 124 on surface 91. In other embodiments this point could be at a smaller radius even though other portions of the keyway may be at a larger radius. In this instance the points at the larger radius may have their extents farther in the un-locking direction than the portion that determines the major extent of the key aperture. The minor extent of the key aperture is generally an arc centered at the center of rotation of a key in the aperture and generally tangent to the smallest radial projection of the key engaging surface into the keyway. The arc in the keyway such as 89 is the smallest radial projection of the key engaging surface. An object with a radius smaller than this arc would rotate without making contact with the tumbler. The angle 93 is the angular measure of the code range for the example the tumbler shown in FIG. 17. Lines 94 through 101 show the locations of the centerlines of possible code notch positions for the example embodiment. In the current example there are 8 possible positions. The dashed arcs such as 102 shown centered on each of the lines 94 through 101 located at the periphery of the tumbler indicate the possible notch locations in the periphery of the tumbler. Notch 103 is located at the position indicated by line 97, for example. The code range angle of the current example embodiment is the angular measure represented by angle 93 and is the angular measure between the center line of the first possible notch position in a tumbler and the last possible notch position in a tumbler. The notch positions for a given embodiment are determined by the number of possible codes for a given tumbler in a given lock.

False notches such as 104 shown in FIG. 17 are located at the positions indicated by lines 95, 99 and 101. The purpose of these false notches is to make the lock more difficult to pick. In the present embodiment, circular notches are shown other embodiments may incorporate notches of other shapes for example triangular, rectangular. False notches are one example of a notch shape that is not circular. In the case of a notch that is not circular the notch angle will be determined by the central location in which the center of the fence member will enter the notch.

FIG. 18A shows an example tumbler 105 with keyway 106 comprising an aperture through which the key enters the tumbler. The keyway has the major extent of its key engaging aperture indicated by the arc 107 and the minor extent of its key engaging aperture 109 defining the key engaging zone 111. The key engaging surfaces such as 110 are within this zone and in the current embodiment are generally straight and non parallel to one another. As mentioned earlier, the form of the surface can be of any shape and size in accordance with the present invention. In other example embodiments, the surfaces may be non-linear or have a combination of suitable shapes and sizes. Lines 112 through 119 are lines drawn coincident with the key engaging surface 110 and then rotated the correct angular distance representing each of the 8 codes for the current example lock. The line at 112 represents code 1 and is rotated 0 degrees in other words it is still coincident with surface 110. The line at 119 represents code 8 and is rotated 90 degrees counter clockwise from its original position at 110. The angle represented by C is the angular span between lines 120 and 121 and is approximately equal to the code range of the example embodiment. Line 120 is drawn from the center of rotation of the key through the intersection of the key engaging surface 110 and the minor extent of the key engaging aperture 109. Line 112 represents the smallest angular displacement of code angles for the example embodiment representing the first code position. Line 121 is drawn from the center of rotation of the key through the intersection of the minor extent of the key engaging aperture and the rotated profile 119 of the key engaging surface having the largest angle of rotation. In other words line 119 represents the farthest angular displacement of code angles for the example embodiment representing the last code position. Angle B is the angular span of the key engaging surface and is measured between line 120 and line 123. Line 123 is drawn from the center of rotation of the key through the intersection of the key engaging surface 110 and the major extent of the key engaging aperture 107. Angle B represents the angular span of the key engaging surface. Angle A is measured between lines 121 and 122. Line 122 is drawn from the center of rotation of the key through the intersection of the minor extent of the key engaging aperture and the second to last rotated profile 118 of the key engaging surface. In other words line 118 is the rotated profile of the key engaging surface having the second largest angle of rotation. Angle A is approximately equal to the angular measure between the last code angle for the lock and the second to last code angle for the lock. In the case of the example embodiment, the code range is 90 degrees. All of the codes in the current example embodiment are equally spaced and there are 8 codes total. The angular measure between each code in this case is equal to 90 degrees divided by 7 which is approximately 12.86 degrees. Thus the angular measure between the last code position and the second to last code position is 12.86 degrees for the example shown in FIG. 18A. In other embodiments the angular measure between the codes may not be equal, to find angle A the angular measure between the last code position and the second to last code position is used.

To prevent a simple key blank from being used to create a key for a lock in accordance with the present invention the key aperture may be restricted at any point along its length to prevent insertion of a key wide enough to create the appropriate cuts to open the lock. Referring to FIG. 8, the current embodiment has restricting surfaces 64 and 65 in guard tumbler 16 that prevent a simple blank of sufficient width from being inserted. The restrictive width of the key aperture E is the maximum width of a simple key blank that may be inserted. This restrictive width exists in the restricting region of the key aperture. This width can be determined by taking the maximum separation between two parallel lines that may be constructed without intersecting any geometry inside of the major extent of the key aperture. This width can be measured on any element making up the keyway of the lock. To prevent a simple blank from being used on a lock in accordance with the present invention the restrictive width of the key aperture is made to be less than or equal to the following formula:

$$E = sin ( \frac{C - A - B}{2} ) * ( R + r )$$

In the formula above:
E is the restrictive width of the key aperture;
C is the code range of the lock;
A is the angular measure between the last code angle for the lock and the second to last code angle for the lock;
B is the angular span of the key engaging surface;
R is the radius of the major extent of the key aperture;
r is the radius of the minor extent of the key aperture.

For a key blank to be capable of opening a lock in accordance with the present invention it must have material in the tumbler engaging zone spanning an angular measure at least as great as the angular measure of the codes for the code tumblers. A key blank of simple construction cannot be used to make a key to open a lock of the current invention when the restrictive width of the key aperture is generally less than the sum of the radius of the major extent of the key aperture and the radius of the minor extent of the key aperture multiplied by the sine of one half of the following: the code range angle of the lock minus the angular measure between the last code angle for the lock and the second to last code angle for the lock minus the angular span of the key engaging surface. In one example embodiment, a key blank of simple construction cannot be used in a disc tumbler lock having a code range angle, the disc tumbler lock including at least: at least one tumbler and a guard tumbler, the at least one tumbler and the guard tumbler defining a keyway aperture there through; wherein the at least one tumbler includes at least: a key engaging surface defining a key engaging zone, the key engaging zone having a first radius defining the major extent of the key engaging zone, and the key engaging zone having a second radius defining the minor extent of the key engaging zone; wherein the guard tumbler defines: a restrictive aperture (or in some embodiments referred to as the restrictive width of the key aperture) including at least a restrictive width having a minimum dimension less than or equal to the sum of the first radius defining the major extent of the key engaging zone and the second radius of the minor extent defining the key engaging zone multiplied by the sine of one half of the following: the code range angle of the lock, minus the angular measure between a last code angle for the lock and a second to last code angle for the lock, minus the angular span of the key engaging surface. These relationships are illustrated by the equation explained above.

One example embodiment provides a keyway for a disc tumbler lock the disc tumbler lock comprising a code range angle, the keyway comprising: an aperture including at least: a key engaging zone; the key engaging zone comprising a radius defining its major extent and a radius defining its minor extent; a restrictive width comprising a minimum dimension less than or equal to the sum of the radius of the major extent of the key aperture and the radius of the minor extent of the key aperture multiplied by the sine of one half of the following: the code range angle of the lock minus the angular measure between the last code angle for the lock and the second to last code angle for the lock minus the angular span of the key engaging surface.

FIG. 13 shows an example embodiment key with code cut positions 71 through 77. The rectangular shape 125 having width E is the widest simple key blank that may be inserted into a lock in accordance with the present invention. It can be seen that this blank could only have codes represented by line 73, 74, 75 and 76 cut into its periphery. This blank would therefore not be capable of opening a lock having any of the codes represented by lines 71, 72, 77 or the surface 126.

In an example embodiment a method is provided for restricting the use of an unauthorized key blank for a disc tumbler lock, the method including at least: restricting the width of at least one element defining a keyway or keyway aperture; providing a restrictive width of a key aperture less than the span necessary to provide tumbler engaging surfaces capable of opening the full ranges of code positions in the disc tumbler lock. In an example embodiment, the at least one element comprises at least one guard tumbler.

In an example embodiment, an method for restricting the use of an unauthorized key blank for a disc tumbler lock is provided, the method including at least: providing a plurality of keyway members (or in an example embodiment, at least one element, for example comprising at least one guard tumbler) defining a restrictive width of a restrictive aperture less than the span necessary to provide tumbler engaging surfaces capable of opening a full range of code positions in the disc tumbler lock; and providing a key having a restricted transverse cross-section complementary with the restrictive width of the restrictive aperture in order for it to be insertable into the key aperture. In an example embodiment, at least one guard tumbler is disposed at the entry of the keyway. In another example embodiment, at least one guard tumbler is disposed at the end of the keyway opposite the keyway entry. In yet another embodiment, a guard tumbler is disposed intermediate in the keyway. In a further embodiment, the guard tumbler may be disposed adjacent the anti drill member in the tumbler stack. In yet another embodiment a restrictive aperture is defined by the endcap and a guard tumbler may or may not be used.

As noted herein, in an example embodiment, the restricted keyway access into the lock body, as provided by the selectively configured guard tumbler, requires that the key also have a complimentarily restricted transverse cross-section in order for it to be insertable into the keyway. This constricted configuration helps to prevent tampering, drilling into the keyway, or unwanted access, and fosters security. In addition, in other embodiments, the guard tumbler protuberances or lobes may be sized, shaped, positioned, or configured to further restrict access thereby requiring a further restricted key cross-section.

In other embodiments certain high-strength materials may be used. For example, in some embodiments, materials such as the following could be used: high-strength steel such as 174PH stainless, carbon steel 4140, or 410 or 440 stainless, S7 tool steel or any other material with suitable properties. With such a configuration, there would be an inverse relationship between the strength of the material used versus the size of the keyway opening. For example, as the strength of the material used for the key is increased, the keyway opening size could suitably decrease.

In use, as noted briefly before, the disk tumbler lock may be used in many various locking applications such as, but not limited, for example, to lock, secure or seal for example, a trucking, shipping, airline or other transportation or security container or cargo containers or used with any disc tumbler, with barrel lock or other types of locks, or used in and with door locks and door locking or other locking hardware. In other example embodiment the locking apparatus can be configured for use in padlocks and other related locking systems and hardware, for shipping and cargo latches or hasps, with locking cables, and for other applications and purposes as well. It should be noted that the locking apparatus and method can be configured, in various nonlimiting example embodiments, for high-security, medium-security, low-security applications and uses as noted herein.

Although there are many possible locking applications, in one example embodiment, the apparatus may used for securing a watthour meter socket ring so as to prevent the separation of two opposing members of the watthour meter socket box ring. The apparatus may also be used as a locking assembly with at least one structure as will hereinafter be explained in further detail.

In one example embodiment, the locking apparatus may be used for securing a sealing ring for a ringed-type meter box. In order to hold a meter in place and prevent its removal from the meter box, both the meter and meter base incorporate a corresponding set of flanges that are retained together with an annular, lockable sealing ring. The lockable sealing ring is designed to encase and captivate the corresponding flanges of the meter and base when the ends of the sealing ring are held or connected together.

In another example embodiment, the locking apparatus may be used for securably connecting a plurality of structures with each of the plurality of structures defining an aperture therein. The plurality of structures preferably comprise first and second ends of a ring, which may be connected or disconnected, the ring being adapted to mount a meter to a meter box structure. Each of the first and second ends of the ring define apertures therein respectively adapted to receive the disk tumbler lock and retaining structure.

In one other example embodiment a system is provided for locking hardware and minimizing tampering with the lock, the system including at least: means for uniting a plurality of structures; means for retaining the means for uniting, wherein the plurality of structures is secured between at least a portion of the means for uniting and at least a portion of the means for retaining.

Various other example embodiments provide a locking apparatus and system that may be adapted for use on any suitable utility service enclosure. Such a utility service enclosure is used not only in the electric utility industry (e.g., a meter box) but also in the gas, water, cable, TV utility industries or in other utility industries.

The embodiments described herein are meant to be examples of the present invention and in no way are intended to limit the scope of the invention. Variation in shape and form of the keyway, number of codes in the lock, angular span of each code angle, geometry of the restrictive surfaces in the aperture and many other variations to other elements of the design are possible within the scope of the invention. The design described does not limit the scope of the embodiments of invention; the number of various elements may change, or various components may be added or removed to the above-described concept, for example, to aid in improved security and operation.

The foregoing disclosure and description of embodiments of the invention is illustrative and explanatory of the above and variations thereof, and it will be appreciated by those skilled in the art, that various changes in the design, organization, order of operation, means of operation, equipment structures and location, methodology, the use of mechanical equivalents, such as different types of fasteners and locking devices than as illustrated whereby different steps may be utilized, as well as in the details of the illustrated construction or combinations of features of the various elements may be made without departing from the spirit of the embodiments of the invention. As well, the drawings are intended to describe various concepts of embodiments of the invention so that presently preferred embodiments of the invention will be plainly disclosed to one of skill in the art but are not intended to be manufacturing level drawings or renditions of final products and may include simplified conceptual views as desired for easier and quicker understanding or explanation of embodiments of the invention. As well, the relative size and arrangement of the components may be varied from that shown and the embodiments of the invention still operate well within the spirit of the embodiments of the invention as described hereinbefore and in the appended claims. Thus, various changes and alternatives may be used that are contained within the spirit of the embodiments of the invention.

Accordingly, the foregoing specification is provided for illustrative purposes only, and is not intended to describe all possible aspects of the example embodiments of the invention. It will be appreciated by those skilled in the art, that various changes in the ordering of steps, ranges, interferences, spacings, hardware, and/or attributes and parameters, as well as in the details of the illustrations or combinations of features of the methods and system discussed herein, may be made without departing from the spirit of the embodiments of the invention. Moreover, while various embodiments of the invention have been shown and described in detail, those of ordinary skill in the art will appreciate that changes to the description, and various other modifications, omissions and additions may also be made without departing from either the spirit or scope thereof.

What is claimed is:

1. A disc tumbler lock having a code range angle, the disc tumbler lock comprising:
at least one tumbler;
a guard tumbler, the at least one tumbler and the guard tumbler defining a keyway aperture there through;
wherein the at least one tumbler comprises:
a key engaging surface defining a key engaging zone,
the key engaging zone having a first radius defining the major extent of the key engaging zone, and the key engaging zone having a second radius defining the minor extent of the key engaging zone; and
wherein the guard tumbler defines:
a restrictive aperture comprising a restrictive width having a minimum dimension less than or equal to the sum of the first radius defining the major extent of the key engaging zone and the second radius of the minor extent defining the key engaging zone multiplied by the sine of one half of the following:
the code range angle of the lock,
minus the angular measure between a last code angle for the lock and a second to last code angle for the lock,
minus the angular span of the key engaging surface.
